(19) United States
(12) Patent Application Publication
(10) Pub. No.: US 2026/0170099 A1
(43) Pub. Date: Jun. 18, 2026

(54) CERTIFICATE MANAGEMENT APPARATUS AND A METHOD THEREOF

(71) Applicants: HYUNDAI MOTOR COMPANY, Seoul (KR); KIA CORPORATION, Seoul (KR)

(72) Inventors: Yoon Ki Park, Hwaseong-si (KR); Myeong Gyu Jeong, Hwaseong-si (KR); Hak Jun Kim, Hwaseong-si (KR)

(73) Assignees: HYUNDAI MOTOR COMPANY, Seoul (KR); KIA CORPORATION, Seoul (KR)

(21) Appl. No.: 19/229,944

(22) Filed: Jun. 5, 2025

(30) Foreign Application Priority Data
Dec. 16, 2024 (KR) 10-2024-0187740

(51) Int. Cl. G06F 21/10

(52) U.S. Cl. CPC G06F 21/1077; G06F 21/1011

(57) ABSTRACT

A certificate management apparatus includes a memory configured to store computer-executable instructions and a processor configured to execute the computer-executable instruction. The processor is configured to generate a first target FoD certificate according to first subscription information for a Feature on Demand (FoD) service based on receiving the first subscription information, generate a second target FoD certificate according to second subscription information different from the first subscription information based on receiving the second subscription information, and determine whether to transmit the second target FoD certificate to a vehicle based on determining whether the first target FoD certificate has been transmitted to the vehicle.

### CROSS-REFERENCE TO RELATED APPLICATION

This application claims the benefit of and priority to Korean Patent Application No. 10-2024-0187740, filed in the Korean Intellectual Property Office on Dec. 16, 2024, the entire contents of which are hereby incorporated herein by reference.

### TECHNICAL FIELD

The present disclosure relates to a certificate management apparatus and a method thereof, and more particularly to a technique for determining to install a certificate in a vehicle based on subscription information for a Firmware on Demand (FoD) service.

### BACKGROUND

Feature on Demand (FoD) is a technology for flexible management of vehicle features, that enables the activation or deactivation of a feature of a specific controller via data communication without reprogramming the controller firmware. This enables the change of the activation status of vehicle features.

If an FoD product is purchased, an activation certificate for the product may be prepared on a distribution server. On the other hand, if a purchased product is requested to be canceled, a deactivation certificate may be prepared. Each of the activation and deactivation certificates includes a serial number called CertSn and may be distinguished through a Tag field. If the Tag is “A,” a certificate may be defined as the activation certificate, and if the Tag is “D,” a certificate may be defined as the deactivation certificate.

The CertSn of the deactivation certificate remains the same as the CertSn of the activation certificate, and if the deactivation certificate is installed in the vehicle, the activation certificate is removed from the executing controller. This allows the vehicle's feature to be ultimately deactivated.

Purchasing an FoD product is similar to regular e-commerce, and a process of installing a certificate in a vehicle after purchase may be considered equivalent to product delivery. If a customer requests a refund, the deactivation certificate must be installed before a refund is issued, just as a shipped item must be retrieved before a refund is issued.

If the customer deliberately avoids turning on the vehicle after the refund, or if installation of the deactivation certificate fails due to factors like a weak signal area, the refund may not be processed. Additionally, if a refund request is made before the product installation, it may be more efficient not to distribute the certificate to the vehicle. Otherwise, if purchases and refunds are repeated, unnecessary activation and deactivation certificates may be installed, causing confusion for the customer.

In the conventional technology, if the customer repeatedly requests purchases and refunds, activation and deactivation certificates may be unnecessarily installed simultaneously. This situation may waste system resources and may have a negative impact on the customer experience.

### SUMMARY

The present disclosure has been made to solve the above-mentioned problems occurring in the prior art while advantages achieved by the prior art are maintained intact.

Aspect of the present disclosure provide a certificate management apparatus and method, that prevent unnecessary installation of activation certificates and deactivation certificates by determining whether to transmit a second target FoD certificate to a vehicle based on determining whether a first target FoD certificate has been transmitted even if customers repeatedly purchase and refund products to save system resources and improve the efficiency of certificate management.

Aspects of the present disclosure provide a certificate management apparatus and method, that reduce unnecessary processes related to certificate installation by transmitting a request to change a status of an FoD certificate to an FoD certification server, and if a request to refund is made before the product is installed, not to distribute the certificate to the vehicle to minimize unnecessary installation and deletion processes for the certificate.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a certificate management apparatus is provided. The certificate management apparatus includes a memory configured to store computer-executable instructions and a processor configured to execute the computer-executable instructions The processor is configured to generate a first target Feature on Demand (FoD) certificate according to first subscription information for a FoD service based on receiving the first subscription information. The processor is also configured to generate a second target FoD certificate according to second subscription information different from the first subscription information based on receiving the second subscription information. The processor is further configured to determine whether to transmit the second target FoD certificate to a vehicle based on determining whether the first target FoD certificate has been transmitted to the vehicle.

In an embodiment, the processor may be configured to receive vehicle status information that includes information on a FoD activation status of the vehicle and whether a FoD certificate is installed, transmit a result of generation of the first target FoD certificate and a result of generation of the second target FoD certificate to a FoD purchase server based on receiving the first subscription information and the second subscription information from the FoD purchase server, determine a history of the first target FoD certificate being installed in the vehicle based on the vehicle status information based on determining that the first subscription information relates to purchase of the FoD service, determine whether an ignition of the vehicle is activated based on determining that there is no history of the first target FoD certificate being installed in the vehicle, and transmit the first target FoD certificate to the vehicle based on the ignition of the vehicle being activated.

In an embodiment, the processor may be configured to receive a result of installation from the vehicle based on the first target FoD certificate being transmitted to the vehicle and installed in the vehicle, transmit a request to change a status of the first target FoD certificate to a FoD certification server based on determining that the result of installation indicates that the installation of the first target FoD certificate is successful, and transmit a request to reissue the first target FoD certificate to the FoD certification server based on determining that the result of installation indicates that the installation of the first target FoD certificate failed.

In an embodiment, the processor may be configured to determine to not transmit the second target FoD certificate to the vehicle based on determining that the second subscription information is received before the first target FoD certificate is transmitted to the vehicle based on the first subscription information relating to the purchase of the FoD service and the second subscription information relating to cancellation of the FoD service.

In an embodiment, the processor may be configured to receive vehicle status information that includes information on a FoD activation status of the vehicle and whether a FoD certificate is installed, determine whether the first target FoD certificate is installed in the vehicle through the vehicle status information based on determining that the second subscription information is received after the first target FoD certificate has been transmitted to the vehicle, transmit the second target FoD certificate to the vehicle based on determining that the first target FoD certificate has been installed in the vehicle, and determine to not transmit the second target FoD certificate to the vehicle based on determining that the first target FoD certificate has not been installed in the vehicle.

According to another aspect of the present disclosure, a certificate management system is provided. The certificate management system includes an FoD purchase server configured to receive information on purchase and cancellation of purchase of an FoD service from a user. The certificate management system also include an FoD certification server configured to generate a FoD certificate for the FoD service. The certificate management system additionally includes a certificate management apparatus configured to transmit the FoD certificate to a vehicle based on information received from the FoD purchase server and the FoD certification server. The FoD purchase server is configured to transmit subscription information for the FoD service to the certificate management apparatus based on receiving the subscription information from the user and receive a result regarding whether the FoD certificate according to the subscription information has been generated, from the certificate management apparatus. The FoD certification server is configured to receive a request to generate the FoD certificate according to the subscription information from the certificate management apparatus, generate the FoD certificate based on the request to generate the FoD certificate, the FoD certificate including at least one of a serial number, a tag, or information on the vehicle, or any combination thereof, and transmit the FoD certificate to the certificate management apparatus.

In an embodiment, the FoD certification server may be configured to receive a request to change a certificate status from the certificate management apparatus after the FoD certificate is installed in the vehicle, and generate information on the FoD certificate being installed in the vehicle based on the request to change the certificate status.

In an embodiment, the certificate management apparatus may be configured to transmit a target link for downloading the FoD certificate to the vehicle, and the FoD certification server may transmit the FoD certificate to the vehicle based on identifying a request to transmit the FoD certificate through the target link.

According to yet another aspect of the present disclosure, a certificate management method is provided. The certificate management method includes generating a first target Feature on Demand (FoD) certificate according to first subscription information for a FoD service based on receiving first subscription information. The certificate management method also includes generating a second target FoD certificate according to second subscription information different from the first subscription information based on receiving second subscription information. The certificate management method additionally includes determining whether to transmit the second target FoD certificate to a vehicle based on determining whether the first target FoD certificate has been transmitted to the vehicle.

In an embodiment, determining whether to transmit the second target FoD certificate may include receiving vehicle status information that includes information on a FoD activation status of the vehicle and whether a FoD certificate is installed, transmitting a result of generation of the first target FoD certificate and a result of generation of the second target FoD certificate to a FoD purchase server based on receiving the first subscription information and the second subscription information from the FoD purchase server, determining a history of the first target FoD certificate being installed in the vehicle based on the vehicle status information based on determining that the first subscription information is information related to purchase of the FoD service, determining whether an ignition of the vehicle is activated based on determining that there is no history of the first target FoD certificate being installed in the vehicle, and transmitting the first target FoD certificate to the vehicle based on the ignition of the vehicle being activated.

In an embodiment, determining whether to transmit the second target FoD certificate may include receiving a result of installation from the vehicle based on the first target FoD certificate being transmitted to the vehicle and installed in the vehicle, transmitting a request to change a status of the first target FoD certificate to a FoD certification server based on determining that the result of installation indicates that the installation of the first target FoD certificate is successful, and transmitting a request to reissue the first target FoD certificate to the FoD certification server based on determining that the result of installation indicates that the installation of the first target FoD certificate failed.

In an embodiment, determining whether to transmit the second target FoD certificate may include determining to not transmit the second target FoD certificate to the vehicle based on determining that the second subscription information is received before the first target FoD certificate is transmitted to the vehicle based on the first subscription information relating to the purchase of the FoD service and the second subscription information relating to cancellation of the FoD service.

In an embodiment, determining whether to transmit the second target FoD certificate may include receiving vehicle status information that includes information on a FoD activation status of the vehicle and whether a FoD certificate is installed, determining whether the first target FoD certificate is installed in the vehicle through the vehicle status information based on determining that the second subscription information is received after the first target FoD certificate has been transmitted to the vehicle, transmitting the second target FoD certificate to the vehicle based on determining that the first target FoD certificate has been installed in the vehicle, and determining to not transmit the second target FoD certificate to the vehicle based on determining that the first target FoD certificate has not been installed in the vehicle.

In an embodiment, determining whether to transmit the second target FoD certificate may include transmitting subscription information for the FoD service to the certificate management apparatus based on receiving the subscription information from a user, and receiving a result regarding whether the FoD certificate has been generated according to the subscription information from the certificate management apparatus, receiving a request to generate the FoD certificate according to the subscription information from the certificate management apparatus, generating the FoD certificate based on the request to generate the FoD certificate, the FoD certificate including at least one of a serial number, a tag, or information on the vehicle, or any combination thereof, and transmitting the FoD certificate to the certificate management apparatus.

In an embodiment, determining whether to transmit the second target FoD certificate may include receiving a request to change a certificate status from the certificate management apparatus after the FoD certificate is installed in the vehicle, and generating information on the FoD certificate being installed in the vehicle based on the request to change the certificate status.

In an embodiment, determining whether to transmit the second target FoD certificate may include transmitting a target link for downloading the FoD certificate to the vehicle, and transmitting the FoD certificate to the vehicle based on identifying a request to transmit the FoD certificate through the target link.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram of a certificate management apparatus, according to an embodiment of the present disclosure;

FIG. 2 is a flowchart for describing a certificate management method, according to an embodiment of the present disclosure;

FIG. 3 is a flowchart for describing a method of installing a certificate in a certificate management system, according to an embodiment of the present disclosure;

FIG. 4 is a flowchart for describing a method of installing a certificate on a vehicle in a certificate management system, according to an embodiment of the present disclosure;

FIG. 5 is a diagram illustrating examples of items included in a FoD certificate, according to an embodiment of the present disclosure; and

FIG. 6 is a diagram illustrating a computing system related to a certificate management apparatus or a certificate management method, according to an embodiment of the present disclosure.

In the description of the drawings, the same or similar reference numerals may be used for the same or similar components.

### DETAILED DESCRIPTION

Hereinafter, embodiments of the present disclosure are described in detail with reference to the accompanying drawings. In adding the reference numerals to the components of each drawing, it should be noted that the identical or equivalent components are designated by the identical reference numerals even if the components are displayed on different drawings. Further, in the following description, where it was determined that a detailed description of well-known features or functions would unnecessarily obscure the gist of the present disclosure, the detailed description thereof has been omitted. Hereinafter, various embodiments of the disclosure may be described with reference to accompanying drawings. However, this is not intended to limit the technology described herein to specific embodiments, and those of ordinary skill in the art should recognize that modifications, equivalents, and/or alternatives on the various embodiments described herein may be variously made without departing from the scope and spirit of the disclosure. With regard to description of drawings, similar components may be marked by similar reference numerals.

In describing the components of the embodiments according to the present disclosure, terms such as first, second, “A”, “B”, (a), (b), and the like may be used. These terms are merely intended to distinguish one component from another component. The terms do not limit the nature, sequence, or order of the constituent components. Unless otherwise defined, all terms used herein, including technical or scientific terms, have the same meanings as those generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present application.

The terms, such as “first”, “second”, and the like used in the disclosure may be used to refer to various components regardless of the order and/or the priority and to distinguish the relevant components from other components, but do not limit the components. For example, “a first user device” and “a second user device” may indicate different user devices regardless of the order or priority. Thus, for example, without departing the scope of the disclosure, a first component may be referred to as a second component, and similarly, a second component may be referred to as a first component.

In the present disclosure, the expressions “have”, “may have”, “include” and “comprise”, “may include”, “may comprise”, or the like, used herein indicate existence of corresponding features (e.g., components such as numeric values, functions, operations, or parts) but do not exclude presence of additional features.

It should be understood that if an component (e.g., a first component) is referred to as being “(operatively or communicatively) coupled with/to” or “connected to” another component (e.g., a second component), the component may be directly coupled with/to or connected with/to the other component or one or more intervening components (e.g., a third component) may be present therebetween. In contrast, if an component (e.g., a first component) is referred to as being “directly coupled with/to” or “directly connected with/to” another component (e.g., a second component), it should be understood that there are no intervening component (e.g., a third component) therebetween.

According to the situation, the expression “configured to” used in the disclosure may be used as, for example, the expression “suitable for”, “having the capacity to”, “designed to”, “adapted to”, “made to”, or “capable of”.

The term “configured (or set) to” does not necessarily mean “specifically designed to” in hardware. Instead, the expression “a device configured to” may mean that the device is “capable of” operating together with another device or other parts. For example, a “processor configured to (or set to) perform A, B, and C” may mean a dedicated processor (e.g., an embedded processor) for performing a corresponding operation or a generic-purpose processor (e.g., a central processing unit (CPU) or an application processor) that performs corresponding operations by executing one or more software programs which are stored in a memory device.

Terms used in the present disclosure are used to describe example embodiments and are not intended to limit the scope of the disclosure. The terms of a singular form may include plural forms unless otherwise specified. All the terms used herein, which include technical or scientific terms, may have the same meaning that is generally understood by a person having ordinary skill in the art. It should be further understood that terms, which are defined in a dictionary and commonly used, should also be interpreted as is customary in the relevant related art and not in an idealized or overly formal unless expressly so defined in various embodiments of the disclosure. In some cases, even if terms are terms which are defined in the disclosure, they may not be interpreted to exclude embodiments of the disclosure.

In the disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. In describing components of embodiments of the present disclosure, each of the phrases “A or B,” “at least one of A and B,” “at least one of A or B,” “A, B or C,” “at least one of A, B and C,” “at least one of A, B, or C” and “at least one of A, B, or C, or any combination thereof” may include any one of items listed along with a relevant phrase, or any possible combination thereof. In particular, phrases such as “at least one of A, B, or C, or any combination thereof” may include A or B or C or a combination thereof such as AB or ABC and/or the like.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, server, and the like may separately embody or be included with a processor and a memory, such as a non-transitory computer readable media, as part of the apparatus.

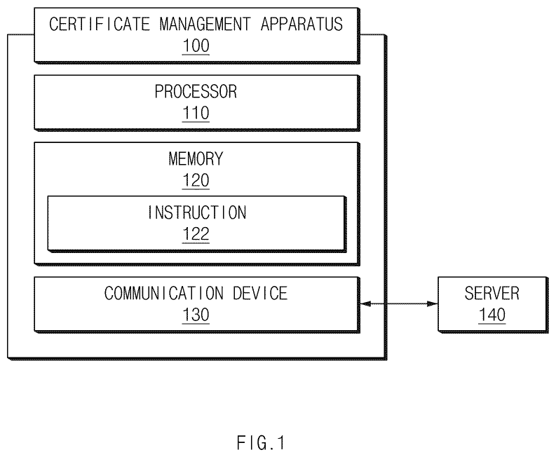

Hereinafter, embodiments of the present disclosure are described in detail with reference to FIGS. 1-6.

FIG. 1 is a block diagram of a certificate management apparatus according to an embodiment of the present disclosure.

A certificate management apparatus 100 according to an embodiment may include a processor 110, a memory 120 including instructions 122, and a communication device 130.

The certificate management apparatus 100 may represent a device that may generate a FoD certificate based on subscription information for a FoD service and may transmit the generated FoD certificate to a vehicle. For example, the certificate management apparatus 100 may generate a certificate based on the FoD subscription information and determine whether to transmit the certificate to the vehicle.

The certificate management apparatus 100 may process vehicle status information and a certificate installation result. The certificate management apparatus 100 may then perform a request to change the state of the certificate or a request to reissue the certificate.

The certificate management apparatus 100 may generate an activation certificate (e.g., a first target FoD certificate) based on purchase information (e.g., first subscription information) for the FoD service.

The certificate management apparatus 100 may generate a deactivation certificate (e.g., a second target FoD certificate) based on purchase cancellation information (e.g., second subscription information).

The certificate management apparatus 100 may efficiently determine whether to transmit a certificate based on the vehicle status information and a FoD activation status.

The certificate management apparatus 100 may determine whether to transmit a certificate based on when a purchase is canceled to avoid unnecessary transmission.

The certificate management apparatus 100 may receive a certificate installation result from the vehicle to determine whether the installation was successful. The certificate management apparatus 100 may transmit a status change request to a server upon successful installation and handle a certificate reissue request upon unsuccessful installation.

The certificate management apparatus 100 may determine whether a certificate installation condition is satisfied by checking the FoD activation status and ignition status of the vehicle. The certificate management apparatus 100 may identify or otherwise determine a history of previously installed certificates on the vehicle to prevent duplicate installations. The certificate management apparatus 100 may transmit a certificate only if the certificate is not installed on the vehicle to reduce resource waste.

The certificate management apparatus 100 may not transmit a deactivation certificate (i.e., a second target FoD certificate) to maximize efficiency if the purchase cancellation information (i.e., the second subscription information) is received prior to the transmission of the activation certificate (i.e., the first target FoD certificate).

The certificate management apparatus 100 may handle a reissue request and a re-installation process in the event of an installation failure, enabling a rapid response. The certificate management apparatus 100 may prevent unnecessary transmissions of activation and deactivation certificates, even in the case of repeated purchases and refunds.

The certificate management apparatus 100 may receive subscription information from a server (e.g., a FoD purchase server) and transmit the result of a generated certificate to the server. The certificate management apparatus 100 may manage the lifecycle of a certificate by transmitting a request to change a certificate status and a request to reissue a certificate to the server (e.g., a FoD certification server).

The processor 110 may execute software (e.g., in the form of computer-readable instructions) to control at least one other component (e.g., hardware or software component) connected to the processor 110. The processor 110 may also perform various data processing or operations. For example, the processor 110 may store a first target FoD certificate, a second target FoD certificate, or the like in the memory 120.

For reference, the processor 110 may perform any operation that the certificate management apparatus 100 performs. Therefore, for ease of description, the operations performed by the certificate management apparatus 100 are primarily described as operations performed by the processor 110. Further, for ease of description, the processor 110 is primarily described herein as being a single processor, but the present disclosure is not limited thereto. For example, the certificate management apparatus 100 may include multiple processors. Each of the multiple processors may at least partially perform all operations associated with generation and processing of a target FoD certificate.

The memory 120 may temporarily and/or permanently store various data and/or information required to perform generation and processing of a target FoD certificate. For example, the memory 120 may store a first target FoD certificate, a second target FoD certificate, or the like.

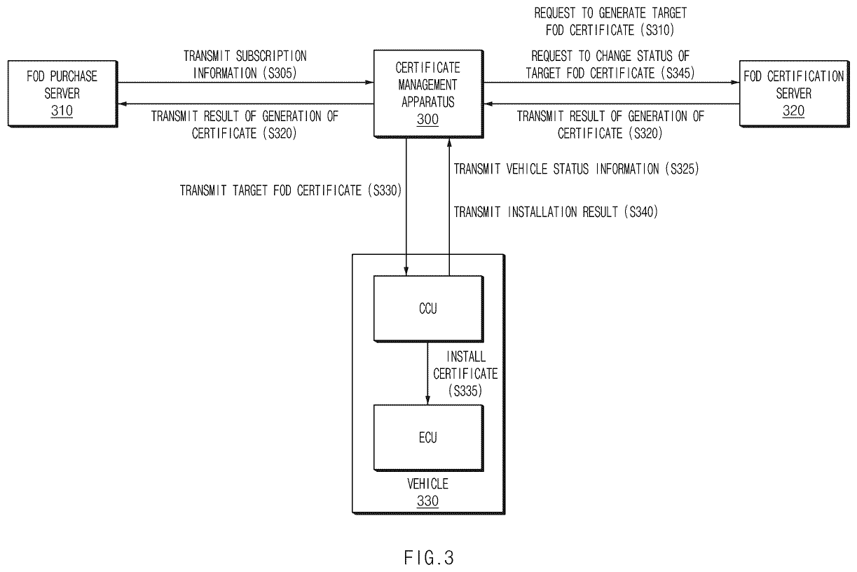

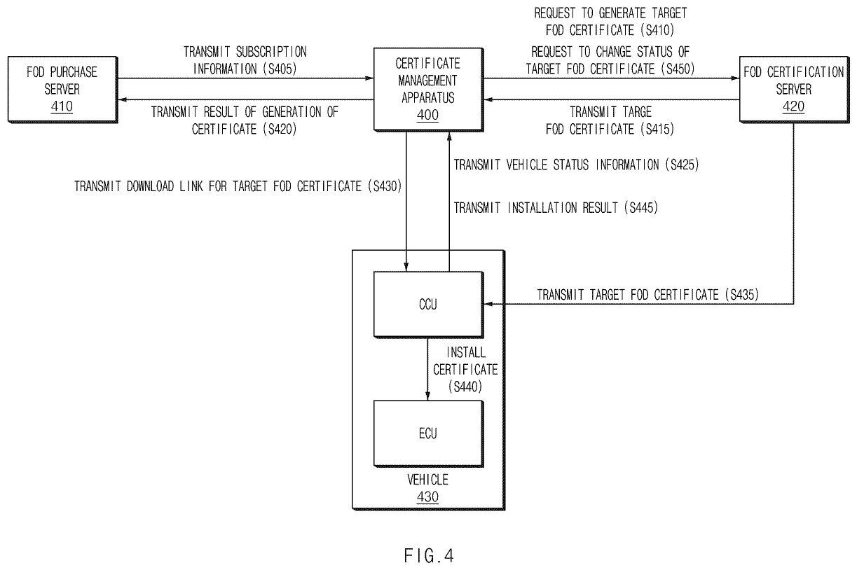

The communication device 130 may support performing communication between the certificate management apparatus 100 and a server 140. For example, the communication device 130 may include one or more components that enable communication between the certificate management apparatus 100 and the server 140. For example, the communication device 130 may include a short range wireless communication device, a microphone, and the like. In this case, short range communication technology may include wireless LAN (Wi-Fi), Bluetooth, ZigBee, WFD (Wi-Fi Direct), UWB (ultra-wideband), infrared communication (IrDA, infrared Data Association), and BLE (Bluetooth Low Energy), NFC (Near Field Communication), or the like, but is not limited thereto. Here, the server 140 may include a FoD purchase server and a FoD certification server. A more detailed description of the server 140, according to an embodiment, is provided below with reference to FIGS. 3 and 4.

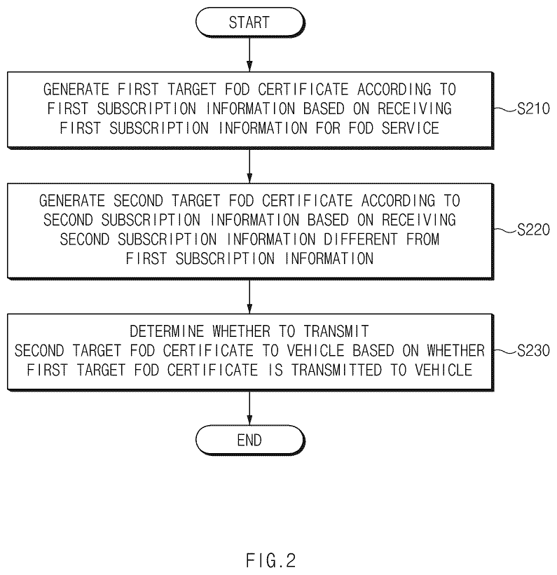

FIG. 2 is a flowchart for describing a certificate management method according to an embodiment of the present disclosure.

In an operation S210, a processor (e.g., the processor 110 of FIG. 1) according to an embodiment may, based on receiving first subscription information for a Feature on Demand (FoD) service, generate a first target FoD certificate according to the first subscription information.

The FoD service may represent a software-based service provided to activate or deactivate a specified feature of the vehicle. The FoD service may be designed to dynamically manage features via data communication without reprogramming controller firmware. The FoD Service may generate an activation certificate or a deactivation certificate at the request of a customer and may transmit the activation certificate or the deactivation certificate to a vehicle to control the statuses of the features.

The first subscription information may include information indicating the purchase of a specified product for the FoD service. The first subscription information may be generated if a customer requests activation of a specified feature through a FoD purchase server. The first subscription information may be used as a reference for generating a certificate (e.g., the first target FoD certificate) to embody an activation state.

The first target FoD certificate is a certificate generated based on the first subscription information and may be used to activate a specified feature of the vehicle. The first target FoD certificate may be installed on a specified controller (e.g., ECU) in the vehicle, and a corresponding feature may be activated after installation. The first target FoD certificate may be transmitted based on the ignition status and activation conditions of the vehicle.

Based on receiving second subscription information that is different from the first subscription information, the processor may, in an operation S220, generate a second target FoD certificate according to the second subscription information.

The second subscription information may be information indicative of cancellation of purchase of a specified product for the FoD service. The second subscription information may be generated if a customer cancels a previously purchased product or requests a refund. The second subscription information may be used as a reference for generating a certificate to implement the deactivation state (second target FoD certificate).

The second target FoD certificate is a certificate generated based on the second subscription information and may be used to deactivate a specified feature of the vehicle. If the second target FoD certificate is installed on the vehicle, the existing activation certificate (e.g., the first target FoD certificate) may be removed, and a corresponding feature may be deactivated. Whether to transmit the second target FoD certificate may be determined by a vehicle status and whether or not the certificate is installed.

In an operation S230, the processor may determine whether to transmit the second target FoD certificate to the vehicle based on determining whether the first target FoD certificate was transmitted to the vehicle.

The vehicle is a means of transportation including a feature that may be activated or deactivated via the FoD service and may include a central control unit (CCU) and an electronic control unit (ECU). The CCU may manage a FoD certificate in the vehicle, transfer the certificate to the ECU, and provide vehicle status information to the certificate management apparatus. The ECU may be a control device that installs the FoD certificate to activate or deactivate a specified feature of the vehicle. The vehicle may determine whether the certificate can be installed based on the ignition status and report an installation result to the certificate management apparatus.

FIG. 3 is a flowchart for describing a method of installing a certificate in a certificate management system according to an embodiment of the present disclosure.

A certificate management system, according to an embodiment, may include a certificate management apparatus 300, a FoD purchase server 310, and a FoD certification server 320.

The FoD purchase server 310 may manage information related to the purchase of FoD service products. In an operation S305, the FoD purchase server 310 may transmit subscription information to the certificate management apparatus 300. The FoD purchase server 310 may receive the result of the certificate generated in operation an S320 from the certificate management apparatus 300 and may store and manage data associated with the history of purchases.

In an embodiment, the FoD purchase server 310 may receive information about the purchase and cancellation of purchase of a FoD service from a user.

The certificate management apparatus 300 may be a device that generates, manages, and transmits certificates associated with the FoD service. The certificate management apparatus 300 may coordinate a process of generating and installing a certificate by communicating with the FoD purchase server 310, the certification server 320, and a vehicle 330. The certificate management apparatus 300 may, in an operation S325, receive vehicle status information, In an operation S355, the certificate management apparatus 300 may perform a request to change the status of the certificate based on the installation results received from an operation S340.

For example, the certificate management apparatus 300 may transmit a FoD certificate to the vehicle 330 based on information received from the FoD purchase server 310 and the FoD certification server 320.

The FoD certification server 320 may generate a target FoD certificate in response to a request from the certificate management apparatus 300 (i.e., an operation S310) and may transmit the target FoD certificate to the certificate management apparatus 300 (i.e., an operation S315). The FoD certification server 320 may update the validity status of the certificate by processing a request to change the certificate status (i.e., an operation S355). The FoD certification server 320 may be a server that generates FoD certificates for the FoD service.

The vehicle 330 may include a central control unit (CCU) and an electronic control unit (ECU), and may have an environment in which the certificate is installed and executed. The CCU of the vehicle 330 may receive a certificate from the certificate management apparatus 300 (i.e., an operation S330), install the certificate on the ECU (i.e., an operation S335), and report the result of the installation to the certificate management apparatus (i.e., an operation S340).

Operations S305 through S320 illustrate operations related to a method of transmitting FoD service subscription information and generating a FoD certificate.

In the operation S305, the FoD purchase server 310 may transmit subscription information. For example, the FoD purchase server 310 may transmit first subscription information (purchase information) to the certificate management apparatus 300 if a customer purchases a FoD service. The FoD purchase server 310 may transmit second subscription information (purchase cancellation information) if the customer requests to cancel the purchase to generate a deactivation certificate. In an embodiment, the FoD purchase server 310 may transmit the subscription information to the certificate management apparatus 300 based on receiving subscription information for the FoD service from a user.

The certificate management apparatus 300 may, in the operation S310, transmit a request to generate a target FoD certificate. For example, the certificate management apparatus 300 may transmit a request to generate the target FoD certificate to the FoD certification server 320 based on the received first subscription information (or second subscription information).

The FoD certification server 320 may, in the operation S315, generate and transmit the FoD certificate. For example, the FoD certification server 320 may generate the requested certificate and may transmit the requested certificate to the certificate management apparatus 300. In this process, an activation certificate or a deactivation certificate may be generated.

The FoD certification server 320 may receive, from the certificate management apparatus 300, a request to generate a FoD certificate according to subscription information. Based on the request to generate a FoD certificate, the FoD certification server 320 may generate a FoD certificate that includes at least one of a serial number, a tag, or vehicle information, or any combination thereof. The FoD certification server 320 may transmit the FoD certificate to the certificate management apparatus 300.

The certificate management apparatus 300 may, in the operation S320, transmit the result of generating the certificate. For example, the certificate management apparatus 300 may transmit the generated certificate result to the FoD purchase server 310 to enable synchronization with purchase history data. The FoD purchase server 310 may receive, from the certificate management apparatus, a result regarding whether a FoD certificate according to the subscription information was generated.

Based on receiving the first subscription information and the second subscription information from the FoD purchase server 310, the certificate management apparatus 300 may transmit the result of generating the first target FoD certificate and the result of generating the second target FoD certificate to the FoD purchase server 310.

Operation S330 and operation S335 may illustrate operations related to a method of transmitting and installing a certificate to the vehicle 330.

In the operation S325, the certificate management apparatus 300 may identify or otherwise determine the status information of the vehicle 330.

The certificate management apparatus 300 may receive vehicle status information that includes information about the FoD activation status of the vehicle 330 and whether the FoD certificate is installed. The certificate management apparatus 300 may identify or otherwise determine a history of the first target FoD certificate being installed on the vehicle based on the vehicle status information if the first subscription information is information regarding the purchase of a FoD service.

The certificate management apparatus 300 may receive vehicle status information that includes information about the FoD activation status of the vehicle 330 and whether the FoD certificate is installed. The certificate management apparatus 300 may identify or otherwise determine, based on the vehicle status information, whether the first target FoD certificate is installed on the vehicle 330 if the second subscription information is received after the first target FoD certificate has been transmitted to the vehicle.

In the operation S330, the certificate management apparatus 300 may transmit the target FoD certificate to the CCU. For example, an activation certificate (i.e., a first target FoD certificate) may be transmitted to activate a vehicle feature, and a deactivation certificate (i.e., a second target FoD certificate) may be transmitted to deactivate an existing activation state.

The certificate management apparatus 300 may identify or otherwise determine whether the vehicle's ignition is activated if the first target FoD certificate has no history of being installed on the vehicle 330.

The certificate management apparatus 300 may transmit the first target FoD certificate to the vehicle based on the vehicle's ignition being activated.

Based on the first subscription information relating to the purchase of the FoD service and the second subscription information relating to the cancellation of the purchase of the FoD service, the certificate management apparatus 300 may determine to not transmit the second target FoD certificate to the vehicle if the second subscription information is received before the first target FoD certificate is transmitted to the vehicle.

The certificate management apparatus 300 may determine to transmit the second target FoD certificate to the vehicle if the first target FoD certificate is installed on the vehicle, and to not transmit the second target FoD certificate to the vehicle if the first target FoD certificate is not installed on the vehicle.

In the operation S335, the vehicle 330 may perform installation of the certificate. For example, the CCU may install the received certificate in the ECU of the vehicle to activate or deactivate a feature.

Operations S340 and S345 illustrate operations related to a method of processing the result of the installation and changing the status of the certificate.

In the operation S340, the CCU of the vehicle 330 may transmit the result of the installation to the certificate management apparatus 300. In an embodiment, a subsequent operation may be determined based on the success or failure of the installation. In an embodiment, in the operation S340, if the installation is completed, the vehicle 330 may report the result of installation to the certificate management apparatus.

The certificate management apparatus 300 may receive the result of the installation from the vehicle 330 based on the first target FoD certificate being transmitted to the vehicle and the first target FoD certificate being installed on the vehicle 330.

If the result of the installation is successful, the certificate management apparatus 300 may, in operation S345, transmit a request to change the certificate status to the FoD certification server 320. In contrast, the certificate management apparatus 300 may repeat the installation by issuing a request to reissue the certificate to the FoD certification server 320 if the result of the installation is unsuccessful.

The FoD certification server 320 may receive a request to change the certificate status from the certificate management apparatus 300 after the FoD certificate is installed on the vehicle 330. Based on the request to change the certificate status, the FoD certification server 320 may generate information indicating that the FoD certificate is installed on the vehicle 330.

In an embodiment, the information indicating that the FoD certificate is installed on the vehicle 330 may be stored as the database record or as data in the form of a digital signature. In an embodiment, the information may include at least one of Vehicle Identification Information, which is information that uniquely identifies the vehicle (e.g., Vehicle Identification Number; VIN), the serial number of the FoD certificate (CertSn), and the installation status, which is status information indicating whether the installation was successful (e.g., “Installed,” “Failed,” “Pending”), Installation Time (Timestamp), which is the exact time and date the certificate was installed, or a function Identifier, which includes a unique identifier of an activated vehicle feature (e.g., cruise control, remote start, etc.), or any combination thereof.

The certificate management apparatus 300 may transmit, to the FoD certification server 320, a request to change the status of the first target FoD certificate if the result of the installation indicates the installation of the first target FoD certificate is successful, to the FoD certification server 320, a request to reissue the first target FoD certificate if the result of the installation indicates the installation of the first target FoD certificate is failed.

FIG. 4 is a flowchart for describing a method of installing a certificate on a vehicle in a certificate management system, according to an embodiment of the present disclosure.

A certificate management system, according to an embodiment, may include a certificate management apparatus 400, a FoD purchase server 410, and a FoD certification server 420.

The FoD purchase server 410 may manage information related to the purchase of FoD service products. The FoD purchase server 410 may, in an operation S405, transmit subscription information to the certificate management apparatus 400. In an operation S420, the FoD purchase server 410 may receive the generated result of the certificate from the certificate management apparatus 400 to store and manage data associated with the purchase history.

In an embodiment, the FoD purchase server 410 may receive information about the purchase and cancellation of purchase of a FoD service from a user.

The certificate management apparatus 400 may be a device that generates, manages, and transmits certificates associated with the FoD service. The certificate management apparatus 400 may coordinate a process of generating and installing a certificate by communicating with the FoD purchase server 410, the FoD certification server 420, and a vehicle 430. The certificate management apparatus 400 may, in an operation S425, receive vehicle status information. In an operation S450, the certificate management apparatus 400 may perform a request to change the status of the certificate based on the installation results received from an operation S440.

For example, the certificate management apparatus 400 may transmit a FoD certificate to the vehicle 430 based on information received from the FoD purchase server 410 and the FoD certification server 420.

The FoD certification server 420 may generate a target FoD certificate in response to a request from the certificate management apparatus 400 (i.e., the operation S410) and may transmit the target FoD certificate to the certificate management apparatus 400 (i.e., the operation S415). The FoD certification server 420 may update the validity status of the certificate by processing a request to change the certificate status (i.e., the operation the S450). The FoD certification server 420 may be a server that generates FoD certificates for the FoD service.

The vehicle 430 may include a central control unit (CCU) and an electronic control unit (ECU), and may have an environment in which the certificate is installed and executed. The CCU of the vehicle 430 may receive a certificate from the certificate management apparatus 400 (i.e., the operation S430), install the certificate on the ECU (i.e., the operation S435), and report the result of the installation to the certificate management apparatus (i.e., the operation S440).

Operations S405 through S420 illustrate operations related to a method of transmitting FoD service subscription information and generating a FoD certificate.

In the operation S405, the FoD purchase server 410 may transmit subscription information. For example, the FoD purchase server 410 may transmit first subscription information (purchase information) to the certificate management apparatus 400 if a customer purchases a FoD service. The FoD purchase server 410 may transmit second subscription information (purchase cancellation information) if the customer requests to cancel the purchase to generate a deactivation certificate. In an embodiment, the FoD purchase server 410 may transmit the subscription information to the certificate management apparatus 400 based on receiving subscription information for the FoD service from a user.

The certificate management apparatus 400 may, in the operation S410, transmit a request to generate a target FoD certificate. For example, the certificate management apparatus 400 may transmit a request to generate the target FoD certificate to the FoD certification server 420 based on the received first subscription information (or second subscription information).

The FoD certification server 420 may, in operation S415, generate and transmit the FoD certificate. For example, the FoD certification server 420 may generate the requested certificate and transmit the requested certificate to the certificate management apparatus 400. In this process, an activation certificate or a deactivation certificate may be generated.

Specifically, the FoD certification server 420 may receive, from the certificate management apparatus 400, a request to generate a FoD certificate according to subscription information. Based on the request to generate a FoD certificate, the FoD certification server 420 may generate a FoD certificate that includes at least one of a serial number, a tag, or vehicle information, or any combination thereof. The FoD certification server 420 may transmit the FoD certificate to the certificate management apparatus 400.

The certificate management apparatus 400 may, in operation S420, transmit the result of generating the certificate. For example, the certificate management apparatus 400 may transmit the generated certificate result to the FoD purchase server 410 to enable synchronization with purchase history data. The FoD purchase server 410 may receive, from the certificate management apparatus, a result regarding whether a FoD certificate according to the subscription information was generated.

Based on receiving the first subscription information and the second subscription information from the FoD purchase server 410, the certificate management apparatus 400 may transmit the result of generating the first target FoD certificate and the result of generating the second target FoD certificate to the FoD purchase server 410.

Operation S430 and operation S435 may illustrate operations related to a method of transmitting and installing a certificate to a vehicle 430.

In operation S425, the certificate management apparatus 400 may identify or otherwise determine the status information of the vehicle 430.

The certificate management apparatus 400 may receive vehicle status information that includes information about the FoD activation status of the vehicle 430 and whether the FoD certificate is installed. The certificate management apparatus 400 may identify or otherwise determine a history of the first target FoD certificate being installed on the vehicle based on the vehicle status information if the first subscription information relates to the purchase of a FoD service.

The certificate management apparatus 400 may receive vehicle status information that includes information about the FoD activation status of the vehicle 430 and whether the FoD certificate is installed, and identify or otherwise determine, based on the vehicle status information, whether the first target FoD certificate is installed on the vehicle 430 if the second subscription information is received after the first target FoD certificate has been transmitted to the vehicle.

The certificate management apparatus 400 may, in operation S430, transmit a download link of the target FoD certificate to the CCU. For example, a download link of an activation certificate (i.e., a first target FoD certificate) may be transmitted to activate a vehicle feature, and a download link of a deactivation certificate (i.e., a second target FoD certificate) may be transmitted to deactivate an existing activation status.

The certificate management apparatus 400 may transmit a target link to download a FoD certificate to the vehicle 430. The FoD certification server 420 may, in operation S435, transmit the FoD certificate to the vehicle 430 based on identifying a request to transmit the FoD certificate via the target link.

The certificate management apparatus 400 may identify or otherwise determine whether the vehicle's ignition is activated if the first target FoD certificate has no history of being installed on the vehicle 430.

The certificate management apparatus 400 may transmit the first target FoD certificate to the vehicle based on the vehicle's ignition being activated.

Based on the first subscription information relating to the purchase of the FoD service and the second subscription information relating to the cancellation of the purchase of the FoD service, the certificate management apparatus 400 may determine to not transmit the second target FoD certificate to the vehicle if the second subscription information is received before the first target FoD certificate is transmitted to the vehicle.

The certificate management apparatus 400 may determine to transmit the second target FoD certificate to the vehicle if the first target FoD certificate is installed on the vehicle, and to not transmit the second target FoD certificate to the vehicle if the first target FoD certificate is not installed on the vehicle.

In operation S440, the vehicle 430 may perform installation of the certificate. For example, the CCU may install the received certificate in the ECU of the vehicle to activate or deactivate a feature.

Operations S445 and S450 illustrate operations related to a method of processing the result of the installation and changing the status of the certificate.

In an operation S445, the CCU of the vehicle 430 may transmit the result of the installation to the certificate management apparatus 400. In an embodiment, a subsequent operation may be determined based on the success or failure of the installation. Accordingly, in the operation S445, if the installation is completed, the vehicle 430 may report the result of installation to the certificate management apparatus.

The certificate management apparatus 400 may receive the result of the installation from the vehicle 430 based on the first target FoD certificate being transmitted to the vehicle and the first target FoD certificate being installed on the vehicle 430.

If the result of the installation is successful, the certificate management apparatus 400 may, in the operation S450, transmit a request to change the certificate status to the FoD certification server 420. On the other hand, the certificate management apparatus 400 may repeat the installation by issuing a request to reissue the certificate to the FoD certification server 420 if the result of the installation is unsuccessful.

The FoD certification server 420 may receive a request to change the certificate status from the certificate management apparatus 400 after the FoD certificate is installed on the vehicle 430. Based on the request to change the certificate status, the FoD certification server 420 may generate information indicating that the FoD certificate is installed on the vehicle 430.

In an embodiment, the information indicating that the FoD certificate is installed on the vehicle 430 may be stored as the database record or as data in the form of a digital signature. The information may include at least one of Vehicle Identification Information, which is information that uniquely identifies the vehicle (e.g., Vehicle Identification Number; VIN), the serial number of the FoD certificate (CertSn), and the installation status, which is status information indicating whether the installation was successful (e.g., “Installed,” “Failed,” “Pending”), Installation Time (Timestamp), which is the exact time and date the certificate was installed, or a function Identifier, which includes a unique identifier of an activated vehicle feature (e.g., cruise control, remote start, etc.), or any combination thereof.

The certificate management apparatus 400 may transmit, to the FoD certification server 420, a request to change the status of the first target FoD certificate if the result of the installation indicates the installation of the first target FoD certificate is successful, to the FoD certification server 420, a request to reissue the first target FoD certificate if the result of the installation indicates the installation of the first target FoD certificate is failed.

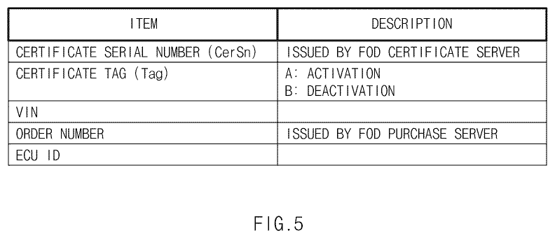

FIG. 5 is a diagram illustrating examples of items included in a FoD certificate, according to an embodiment.

FIG. 5 illustrates examples of items included in a FoD certificate, according to an embodiment. For example, the FoD certificate may include a first target FoD certificate or a second target FoD certificate.

A certificate serial number (CertSn) is a unique identifier for the FoD certificate, that may be issued by a FoD certification server. The certificate serial number may uniquely identify the certificate and may be used to associate the certificate with a vehicle.

The certificate tag may be used to distinguish between an activation certificate and a deactivation certificate. The certificate tag may include a field that indicates the status of the certificate (activation or deactivation). As an example of a value, “A” may represent an activation certificate and “B” may represent a deactivation certificate. The certificate tag may control whether a vehicle feature is activated, and define what the certificate should do (activation or deactivation).

The vehicle identification number (VIN) is an identification number that uniquely identifies a vehicle. The VIN may be used as reference information for applying a certificate to a specific vehicle. In particular, the VIN may be utilized as a security factor to prevent incorrect application of a certificate to the vehicle.

An order number is a unique order number generated if a customer and/or user purchases a product through a FoD purchase server. The order number is used to track purchase history and distinguish between customer requests (purchase or cancellation) when generating a certificate. Also, the order number is required for data synchronization with the FoD purchase server.

An ECU ID is information used to identify or otherwise determine an Electronic Control Unit (ECU) in a vehicle where a certificate must be installed. The identification information may prevent an incorrect feature from being activated on other control units in the vehicle by allowing the certificate to be installed in a specified ECU. The identification information may enable efficient certificate installation by specifying the identity (ID) of the ECU that needs to be installed.

The certificate serial number may be associated with the vehicle identification number (VIN) to identify or otherwise determine which features need to be activated/deactivated on a specific vehicle. The certificate tag value may determine what a relevant certificate should perform (activation or deactivation). The order number may be associated with the CertSn and may be a reference for tracking the customer's purchase request and certificate issuance information, and changing the status of the certificate or reissuing the certificate in the event of a purchase or refund request. The ECU ID may limit the scope of the certificate installation and prevent conflicts between control units in the vehicle. For example, the ECU ID may specify a feature (e.g., cruise control) that needs to be activated only on a certain ECU.

The items shown in FIG. 5 may include all the information needed for a FoD certificate to activate or deactivate a specific feature in the vehicle. Each item is key data to efficiently manage the process of issuing, transmitting, installing, and changing the status of a certificate. It is possible to improve security by restricting the certificate to apply only to specific vehicles and specific features based on the VIN and CertSn. The order number may enable tracking the history of purchase and cancellation to clearly manage a certificate status at the customer's request.

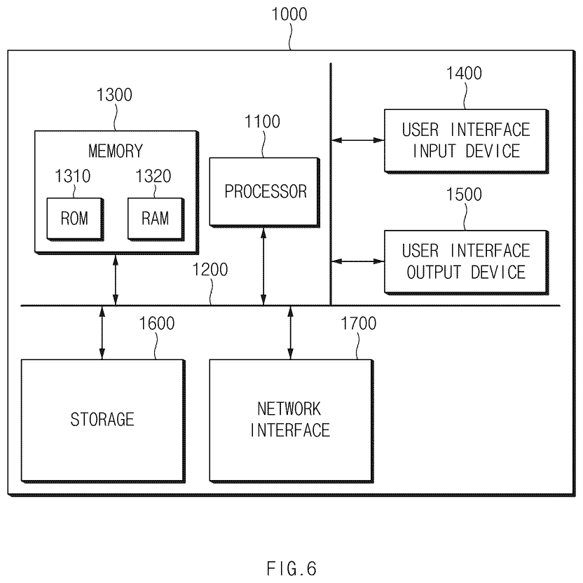

FIG. 6 is a diagram illustrating a computing system related to a certificate management apparatus or a certificate management method, according to an embodiment of the present disclosure.

Referring to FIG. 6, a computing system 1000 for a certificate management apparatus or a certificate management method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read Only Memory (ROM) and a Random Access Memory (RAM).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those having ordinary skill in the art to which the present disclosure pertains.

The embodiments described herein may be implemented with hardware components and software components and/or a combination of the hardware components and the software components. For example, the apparatus, method and components described in the embodiments may be implemented using a general-purpose or special purpose computers, such as a processor, a controller and an arithmetic logic unit (ALU), a digital signal processor, a microcomputer, a field programmable array (FPGA), a programmable logic unit (PLU), a microprocessor or any other device capable of executing and responding to instructions. The processing device may run an operating system (OS) and a software application that runs on the OS. The processing device also may access, store, manipulate, process, and create data in response to execution of the software. For convenience of understanding, one processing device is described as being used, but those having ordinary skill in the art should appreciate that the processing device includes a plurality of processing elements and/or multiple types of processing elements. For example, the processing device may include multiple processors or a single processor and a single controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by a computer readable recording media.

The above-described methods may be embodied in the form of program instructions that may be executed by various computer means and recorded on a computer-readable medium. The computer-readable medium may include program instructions, data files, data structures, and/or the like, singly or in combination, and the program instructions recorded on the medium may be those specially designed and constructed for the purposes of the inventive concept, or they may be of the kind well-known and available to those having skill in the computer software arts. Examples of computer readable recording media include magnetic media such as hard disks, floppy disks and magnetic tape, optical media such as CD-ROMs, DVDs, and magnetic disks such as floppy disks, Magneto-optical media, and hardware devices specifically configured to store and execute program instructions, such as ROM, RAM, flash memory, and the like. Examples of program instructions include not only machine code generated by a compiler, but also high-level language code that may be executed by a computer using an interpreter or the like.

The hardware device described above may be configured to operate as one or a plurality of software modules to perform the operations of the present disclosure, and vice versa.

Although the embodiments have been described by the example embodiments and the drawings as described above, various modifications and variations are possible to those having ordinary skill in the art from the above description. For example, the described techniques may be performed in a different order than the described method, and/or components of the described systems, structures, devices, circuits, etc. may be combined or combined in a different form than the described method, or other components, or even if replaced or substituted by equivalents, an appropriate result may be achieved.

Therefore, other implementations, other embodiments, and equivalents to the claims are within the scope of the following claims.

Accordingly, the embodiments describes in the present disclosure are not intended to limit the technical idea of the present disclosure but to describe the present disclosure, and the scope of the technical idea of the present disclosure is not limited by the described embodiments. The scope of protection of the present disclosure should be interpreted by the following claims, and all technical ideas within the scope equivalent thereto should be construed as being included in the scope of the present disclosure.

The effects of the certificate management apparatus and the method thereof according to some embodiments of the present disclosure are given as follows.

According to at least one of embodiments of the present disclosure, it is possible to prevent unnecessary installation of activation certificates and deactivation certificates by determining whether to transmit a second target FoD certificate to the vehicle based on determining whether a first target FoD certificate has been transmitted even if customers repeatedly purchase and refund products, thereby saving system resources and improving the efficiency of certificate management.

In addition, according to at least one of embodiments of the present disclosure, it is possible to reduce unnecessary processes related to certificate installation by transmitting a request to change a status of an FoD certificate to the FoD certification server, and if a request to refund is made before the product is installed, not to distribute the certificate to the vehicle, thereby minimizing unnecessary installation and deletion processes for the certificate.

In addition, various effects may be provided that are directly or indirectly understood through the disclosure.

Hereinabove, although the present disclosure has been described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

What is claimed is:

1. A certificate management apparatus comprising:
a memory configured to store computer-executable instructions; and
a processor configured to execute the computer-executable instructions,
wherein the processor is configured to:
generate a first target Feature on Demand (FoD) certificate according to first subscription information for a FoD service based on receiving the first subscription information,
generate a second target FoD certificate according to second subscription information different from the first subscription information based on receiving the second subscription information, and
determine whether to transmit the second target FoD certificate to a vehicle based on determining whether the first target FoD certificate has been transmitted to the vehicle.

2. The certificate management apparatus of claim 1, wherein the processor is configured to:
receive vehicle status information that includes information on a FoD activation status of the vehicle and whether a FoD certificate is installed;
transmit a result of generation of the first target FoD certificate and a result of generation of the second target FoD certificate to a FoD purchase server based on receiving the first subscription information and the second subscription information from the FoD purchase server;
determine a history of the first target FoD certificate being installed in the vehicle based on the vehicle status information based on determining that the first subscription information relates to purchase of the FoD service;
determine whether an ignition of the vehicle is activated based on determining that there is no history of the first target FoD certificate being installed in the vehicle; and
transmit the first target FoD certificate to the vehicle based on the ignition of the vehicle being activated.

3. The certificate management apparatus of claim 2, wherein the processor is configured to:
receive a result of installation from the vehicle based on the first target FoD certificate being transmitted to the vehicle and installed in the vehicle;
transmit a request to change a status of the first target FoD certificate to a FoD certification server based on determining that the result of installation indicates that the installation of the first target FoD certificate is successful; and
transmit a request to reissue the first target FoD certificate to the FoD certification server based on determining that the result of installation indicates that the installation of the first target FoD certificate failed.

4. The certificate management apparatus of claim 1, wherein the processor is configured to determine to not transmit the second target FoD certificate to the vehicle based on determining that the second subscription information is received before the first target FoD certificate is transmitted to the vehicle based on the first subscription information relating to purchase of the FoD service and the second subscription information relating to cancellation of the FoD service.

5. The certificate management apparatus of claim 4, wherein the processor is configured to:
receive vehicle status information that includes information on a FoD activation status of the vehicle and whether a FoD certificate is installed;
determine whether the first target FoD certificate is installed in the vehicle through the vehicle status information based on determining that the second subscription information is received after the first target FoD certificate has been transmitted to the vehicle;
transmit the second target FoD certificate to the vehicle based on determining that the first target FoD certificate has been installed in the vehicle; and
determine to not transmit the second target FoD certificate to the vehicle based on determining that the first target FoD certificate has not been installed in the vehicle.

6. A certificate management system comprising:
an FoD purchase server configured to receive information, provided by a user, on purchase and cancellation of purchase of an FoD service;
an FoD certification server configured to generate a FoD certificate for the FoD service; and
a certificate management apparatus configured to transmit the FoD certificate to a vehicle based on information received from the FoD purchase server and the FoD certification server,
wherein the FoD purchase server is configured to:
transmit subscription information for the FoD service to the certificate management apparatus based on receiving the subscription information from the user, and
receive a result regarding whether the FoD certificate according to the subscription information has been generated, from the certificate management apparatus, and
wherein the FoD certification server is configured to:
receive a request to generate the FoD certificate according to the subscription information from the certificate management apparatus,
generate the FoD certificate based on the request to generate the FoD certificate, the FoD certificate including at least one of a serial number, a tag, or information on the vehicle, or any combination thereof, and
transmit the FoD certificate to the certificate management apparatus.

7. The certificate management system of claim 6, wherein the FoD certification server is configured to:
receive a request to change a certificate status from the certificate management apparatus after the FoD certificate is installed in the vehicle; and
generate information on the FoD certificate being installed in the vehicle based on the request to change the certificate status.

8. The certificate management system of claim 6, wherein the certificate management apparatus is configured to transmit a target link for downloading the FoD certificate to the vehicle, and
wherein the FoD certification server is configured to transmit the FoD certificate to the vehicle based on identifying a request to transmit the FoD certificate through the target link.

9. A certificate management method comprising:
generating a first target Feature on Demand (FoD) certificate according to first subscription information for a FoD service based on receiving the first subscription information;
generating a second target FoD certificate according to second subscription information different from the first subscription information based on receiving the second subscription information; and
determining whether to transmit the second target FoD certificate to a vehicle based on determining whether the first target FoD certificate has been transmitted to the vehicle.

10. The certificate management method of claim 9, wherein determining whether to transmit the second target FoD certificate includes:
receiving vehicle status information that includes information on a FoD activation status of the vehicle and whether a FoD certificate is installed;
transmitting a result of generation of the first target FoD certificate and a result of generation of the second target FoD certificate to a FoD purchase server based on receiving the first subscription information and the second subscription information from the FoD purchase server;
determining a history of the first target FoD certificate being installed in the vehicle based on the vehicle status information based on determining that the first subscription information is information related to purchase of the FoD service;
determining whether an ignition of the vehicle is activated based on determining that there is no history of the first target FoD certificate being installed in the vehicle; and
transmitting the first target FoD certificate to the vehicle based on the ignition of the vehicle being activated.

11. The certificate management method of claim 10, wherein the determining of whether to transmit the second target FoD certificate includes:
receiving a result of installation from the vehicle based on the first target FoD certificate being transmitted to the vehicle and installed in the vehicle;
transmitting a request to change a status of the first target FoD certificate to a FoD certification server based on determining that the result of installation indicates that the installation of the first target FoD certificate is successful; and
transmitting a request to reissue the first target FoD certificate to the FoD certification server based on determining that the result of installation indicates that the installation of the first target FoD certificate is failed.

12. The certificate management method of claim 9, wherein determining whether to transmit the second target FoD certificate includes determining to not transmit the second target FoD certificate to the vehicle based on determining that the second subscription information is received before the first target FoD certificate is transmitted to the vehicle based on the first subscription information relating to purchase of the FoD service and the second subscription information relating to cancellation of the FoD service.

13. The certificate management method of claim 12, wherein determining whether to transmit the second target FoD certificate includes:
receiving vehicle status information that includes information on a FoD activation status of the vehicle and whether a FoD certificate is installed;
identifying whether the first target FoD certificate is installed in the vehicle through the vehicle status information based on determining that the second subscription information is received after the first target FoD certificate has been transmitted to the vehicle;
transmitting the second target FoD certificate to the vehicle based on determining that the first target FoD certificate has been installed in the vehicle; and
determining to not transmit the second target FoD certificate to the vehicle based on determining that the first target FoD certificate has not been installed in the vehicle.

14. The certificate management method of claim 9, wherein the determining of whether to transmit the second target FoD certificate includes:
transmitting subscription information for the FoD service to a certificate management apparatus based on receiving the subscription information provided by a user;
receiving a result regarding whether the FoD certificate has been generated according to the subscription information from the certificate management apparatus;
receiving a request to generate the FoD certificate according to the subscription information from the certificate management apparatus;
generating the FoD certificate based on the request to generate the FoD certificate, the FoD certificate including at least one of a serial number, a tag, or information on the vehicle, or any combination thereof; and
transmitting the FoD certificate to the certificate management apparatus.

15. The certificate management method of claim 14, wherein determining whether to transmit the second target FoD certificate includes:
receiving a request to change a certificate status from the certificate management apparatus after the FoD certificate is installed in the vehicle; and
generating information on the FoD certificate being installed in the vehicle based on the request to change the certificate status.

16. The certificate management method of claim 14, wherein determining whether to transmit the second target FoD certificate includes:
transmitting a target link for downloading the FoD certificate to the vehicle; and
transmitting the FoD certificate to the vehicle based on identifying a request to transmit the FoD certificate through the target link.
